(19) United States
(12) Patent Application Publication
(10) Pub. No.: US 2008/0049808 A1
(43) Pub. Date: Feb. 28, 2008

(54) Method for appraising bodies

(75) Inventor: Akram El Jarad, Hamburg (DE)

Correspondence Address: DAVIDSON, DAVIDSON & KAPPEL, LLC, 485 SEVENTH AVENUE, 14TH FLOOR, NEW YORK, NY, 10018, US

(73) Assignee: Ibea Ingenieurburo fur Eletronik und Automation GMBH, Hamburg (DE)

(21) Appl. No.: 11/803,791

(22) Filed: May 16, 2007

(30) Foreign Application Priority Data
May 16, 2006 (DE) DE102006023144.9

(51) Int. Cl. G01N 25/72; G01N 29/04

(52) U.S. Cl. 374/5; 73/600

(57) ABSTRACT

A method is disclosed for appraising a body having low heat conduction by detecting a temperature field of the body, the body being energetically influenced via its surface, the temperature field of the energetically influenced body being detected simultaneously or subsequently, and evaluation being performed as a function of the detected temperature field, influencing being performed at low power.

The present invention relates to the field of the methods for appraising bodies, in particular of ultrasonic thermography for crack detection.

Methods of this type are known, for example, from DE 196 23 159 C2. A method for appraising a body is disclosed in this document, the body being energetically influenced via its surface in a treatment station, the temperature field of the energetically influenced body being detected simultaneously or subsequently, and evaluation being performed in an evaluation station as a function of the temperature field.

The method according to DE 196 23 159 C2 is used above all for evaluating and appraising metallic bodies, such as sheet metal. However, it has been shown in practice that it would be desirable to also be able to use a method of this type for bodies having lesser heat conduction. This has not been possible in practice up to this point, however, because the testing time in applications according to the related art, in particular DE 196 23 159 C2, are usually too long. However, an improved method would allow automation having lower cycle times, for example.

It is therefore an object of the present invention to provide a method for appraising bodies having lower heat conduction, in particular bodies having a heat conduction of ≦5 W/mK.

This object is achieved by claim 1 of the present invention. Accordingly, a method for appraising a body having a heat conduction of ≦5 W/mK, in particular a surface and/or surface-proximal areas thereof, is provided by detecting a temperature field of the body, the body being energetically influenced via its surface, the temperature field of the energetically influenced body being detected simultaneously or subsequently, and an appraisal being performed as a function of the detected temperature field, characterized in that the supplied energy is ≦500 Ws for energetic influencing.

Surprisingly, it has been found that with such an energetically low influence, accurate and efficient appraisal is possible within a wide span of the applications of the present invention. In particular, the body may thus be examined for cracks and/or fissures. Furthermore, at least one of the following advantages is achieved within a wide span of the applications of the present invention by a method according to the present invention:
Due to the smaller amount of energy which is supplied to the body, it is influenced only insignificantly or not at all by the appraisal method, in particular it is not heated or deformed.
The body is only slightly heated by the method according to the present invention. It has been established that the heating essentially only occurs in the area of the point of introduction and at the crack. Possible damage to the body only occurs in the area of the crack, because only flawed points are excited. Only insignificant deformation of the body could be established or none at all in practice.
Because of the lower energy output which is supplied to the body, it is possible to implement the method using a simple and uncomplicated method apparatus.
Because the body is only slightly influenced, it may be supplied to further method steps (e.g., during production) directly after the method, without cooling, etc., being necessary.
Automated quality control of materials having a low coefficient of thermal conductivity is made possible by the method according to the present invention within a wide span of the applications of the present invention. In some applications, a cycle rate of at least 300 pieces per minute, sometimes even 400 or 500 pieces, may be achieved.
Within a wide span of the applications and according to a preferred embodiment of the present invention, a simple camera, such as a bolometer camera, in particular a bolometer camera having a low resolution, such as 160×120 pixels and 50 Hz frame rate, suffices for detecting the temperature field due to the method according to the present invention. It is assumed (without being restricted thereto) that on the one hand this results in the fact that the heat is only distributed very slowly as a result of the low thermal conductivity of the test body. In addition, it is significant that although the energy used is ≦500 Ws, the temperature differences produced in the body are so great that high sensitivity of the camera is not necessary within a wide span of the applications of the present invention.

The present invention relates in particular to a method for appraising bodies having a heat conduction of ≦3 W/mK, also in particular to methods for appraising bodies having a heat conduction of ≦1 W/mK.

According to a preferred embodiment of the present invention, the energy supplied during energetic influencing is ≦300 Ws. An even more gentle examination may thus be achieved within a wide span of the applications of the present invention.

According to a preferred embodiment of the present invention, the energy supplied during energetic influencing is ≦100 Ws.

According to a preferred embodiment of the present invention, the body is energetically influenced for a time of >0 ms and ≦500 ms. The method may thus be designed as even more efficient, in particular more time-efficient, within a wide span of the applications of the present invention, without negatively influencing the quality of the method.

According to a preferred embodiment of the present invention, the body is energetically influenced for a time of ≧50 ms and ≦300 ms. It has been shown that this time is sufficient within a wide span of the applications of the present invention to be able to perform a sufficiently precise appraisal.

According to a preferred embodiment of the present invention, the body is energetically influenced for a time of ≧100 ms and ≦200 ms.

According to a preferred embodiment of the present invention, the body is energetically influenced using an energy source having an output of ≧200 W and ≦5000 W. The method may thus be designed as even more gentle within a wide span of the applications of the present invention, without negatively influencing the quality of the method; unexacting and conventional energy sources such as an ultrasonic hand welding unit may thus also be used within a wide span of the applications of the present invention.

According to a preferred embodiment of the present invention, the body is energetically influenced using an energy source having an output of ≧500 W and ≦2500 W. It has been shown that an energy source having this output is sufficient to be able to perform a sufficiently precise appraisal within a wide span of the applications of the present invention.

According to a preferred embodiment of the present invention, the body is energetically influenced using an energy source having an output of ≧750 W and ≦1500 W.

According to a preferred embodiment of the present invention, energetic influencing is performed by ultrasound injection and/or using ultrasound, preferably in the range from ≧10 kHz to ≦100 kHz, more preferably ≧20 kHz to ≦35 kHz. This has been shown to be advantageous in practice for a wide span of applications within the present invention.

According to a preferred embodiment of the present invention, during the measurement of the temperature field, only a part of the body is detected and energetic influencing occurs at another point of the body, which is not detected by the measurement of the temperature field. This allows less-influenced measurement of the temperature field within a wide span of the applications of the present invention; in addition, the body is less stressed by the measurement.

According to a preferred embodiment of the present invention, the body includes a top side and a bottom side, the top side of the body being detected during the measurement of the temperature field and energetic influencing being performed on the bottom side of the body.

According to a preferred embodiment of the present invention, the body includes a top side and a bottom side and at least one other side, the top side of the body being detected during the measurement of the temperature field and energetic influencing occurring on the bottom side or one of the other sides of the body.

The present invention additionally relates to a device for performing the method according to the present invention.

The device preferably contains an ultrasound unit for energetic influencing of the body, whereby an ultrasonic coupling in the range from ≧10 kHz to ≦100 kHz, preferably ≧20 kHz to ≦35 kHz is preferably generated.

The above-mentioned components and the components claimed and to be used according to the present invention as described in the exemplary embodiments are not subject to any special exceptional conditions in regard to their size, shaping, material selection, and technical conception, so that the selection criteria known in the area of application may be applied without restriction.

Further characteristics, features, and advantages of the subject matter of the present invention result from the subclaims and the following description of the associated drawings, in which multiple exemplary embodiments of the method according to the present invention are illustrated as examples.

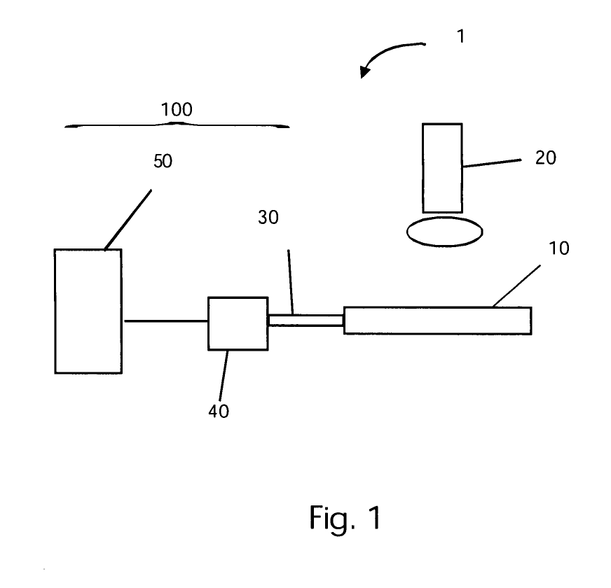

FIG. 1 shows a highly schematic illustration of a device for performing the method according to a first embodiment of the present invention; and

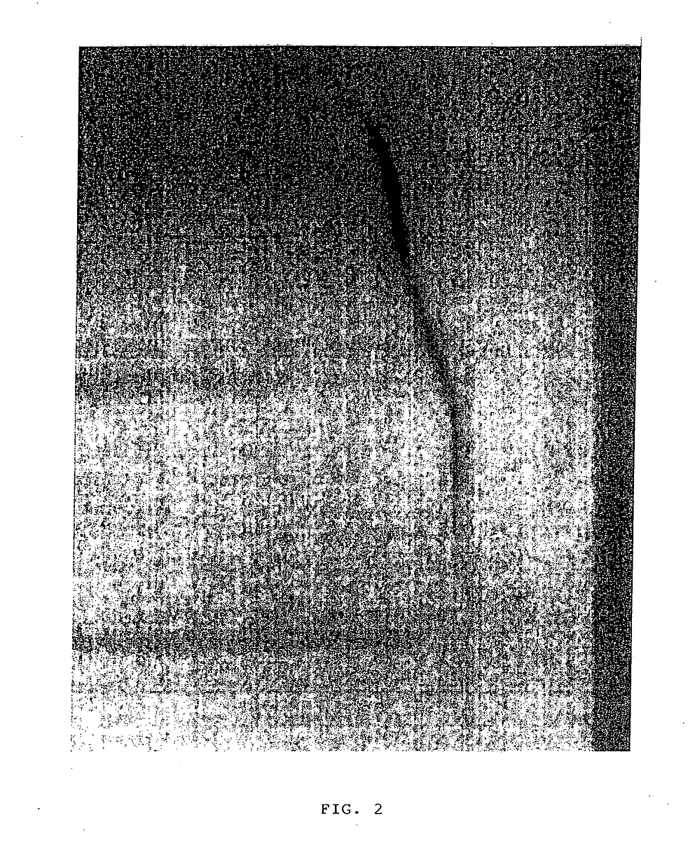

FIG. 2 shows a temperature image of the body which has been influenced according to a second embodiment of the present invention.

FIG. 1 shows a highly schematic illustration of a device 1 for performing the method according to a first embodiment of the present invention.

The device also includes an ultrasound unit 100, which includes an ultrasound generator 50, which drives a converter 40 having a sonotrode 30. Using sonotrode 30, body 10 to be examined may be energetically influenced and a temperature image may then be recorded using camera 20, which is preferably an IR camera. The converter preferably operates at an ultrasonic frequency of 20-35 kHz.

It is to be briefly noted that—as described above—it is preferable in particular if energetic influencing of body 10 by sonotrode 30 occurs on the side of the body which is not detected by camera 20. This has been proven to be advantageous in many applications, because the quality of the thermal image may thus be maximized and also the stress of body 10 may be minimized.

FIG. 2 shows a thermal image of the body which has been influenced according to a second embodiment of the present invention. This is a roof tile, which has been influenced from the side for 200 ms using 1000 W ultrasound. The crack in the roof tile may be seen clearly as a bright spot in the thermal image.

1. A method for appraising a body having a heat conduction of ≦5 W/mK, in particular a surface and/or surface-proximal areas thereof, while detecting a temperature field of the body, the body being energetically influenced over its surface, the temperature field of the energetically influenced body being detected simultaneously or subsequently, and evaluation being performed as a function of the detected temperature field, wherein the energy supplied during energetic influencing is ≦500 Ws.

2. The method as recited in claim 1, wherein the energy supplied during energetic influencing is ≦300 Ws.

3. The method as recited in claim 1, wherein the energy supplied during energetic influencing is ≦100 Ws.

4. The method as recited in claim 1, wherein the body is energetically influenced for a time of >0 ms and ≦500 ms.

5. The method as recited in claim 1, wherein the body is energetically influenced for a time of ≧50 ms and ≦300 ms.

6. The method as recited in claim 1, wherein the body is energetically influenced for a time of ≧100 ms and ≦200 ms.

7. The method as recited in claim 1, wherein the body is energetically influenced using an energy source having an output of ≧200 W and ≦5000 W.

8. The method as recited in claim 1, wherein the body is energetically influenced using an energy source having an output of ≧500 W and ≦2500 W.

9. The method as recited in claim 1, wherein the body is energetically influenced using an energy source having an output of ≧750 W and ≦1500 W.

10. The method as recited in claim 1, wherein only a part of the body is detected during the measurement of the temperature field and energetic influencing occurs at a point of the body which is not detected by the measurement of the temperature field.

11. The method as recited in claim 10, wherein the body includes a top side and a bottom side, the top side of the body being detected during the measurement of the temperature field and energetic influencing occurring on the bottom side of the body.

12. The method as recited in claim 10, wherein the body includes a top side and a bottom side and at least one other side, the top side of the body being detected during the measurement of the temperature field and energetic influencing occurring on the bottom side or one of the other sides of the body.

13. The method as recited in claim 1, wherein energetic influencing is performed by ultrasound injection and/or using ultrasound, preferably in the range from ≧10 kHz to ≦100 kHz, more preferably ≧20 kHz to ≦35 kHz.

14. A device for performing the method as recited in claim 1.

15. The device as recited in claim 14, wherein the device includes an ultrasound unit.

16. The device as recited in claim 15, wherein the ultrasound unit influences the body using ultrasonic coupling in the range from ≧10 kHz to ≦100 kHz.

17. The device as recited in claim 15, wherein the ultrasound unit influences the body using ultrasonic coupling in the range from ≧20 kHz to ≦35 kHz.
